(19) United States
(12) Patent Application Publication
(10) Pub. No.: US 2026/0187231 A1
(43) Pub. Date: Jul. 2, 2026

(54) ANOMALY DETECTION SYSTEM, ANOMALY DETECTION METHOD, ELECTRONIC DEVICE AND STORAGE MEDIUM

(71) Applicant: SKSPRUCE TECHNOLOGIES CO., LTD., Chengdu (CN)

(72) Inventors: Yongcheng LEI, Chengdu (CN); Yee SOON, Chengdu (CN); Fang WU, Chengdu (CN); Siyuan WANG, Chengdu (CN)

(21) Appl. No.: 19/411,459

(22) Filed: Dec. 8, 2025

(30) Foreign Application Priority Data
Dec. 29, 2024 (CN) 202411956853.2

(51) Int. Cl. G06F 21/55

(52) U.S. Cl. CPC G06F 21/552; G06F 21/554

(57) ABSTRACT

An anomaly detection system, an anomaly detection method, an electronic device and a storage medium are provided, which relates to the field of artificial intelligence. The anomaly detection system includes a plurality of markers. The plurality of markers are different from each other and correspond to different anomaly detection operations. A log line of a target system may be detected from different dimensions by using the plurality of markers, and marker tokens generated by different markers are obtained. In addition, the anomaly detection system further includes a model marker. The model marker may combine the marker tokens respectively generated by each marker into a token sequence and perform anomaly detection on the token sequence by using a pre-trained neural network model to obtain an overall anomaly score of the target system within a preset time period.

### CROSS REFERENCE OF RELATED APPLICATION

The present invention claims priority under 35 U.S.C. § 119 to Chinese Patent Application No. 202411956853.2, filed on Dec. 29, 2024, the entire content of which is incorporated herein by reference.

### FIELD

The present disclosure relates to the field of artificial intelligence, and particularly to an anomaly detection system, an anomaly detection method, an electronic device and a storage medium.

### BACKGROUND

In modern massive-scale computing environment, the vast amount of logs generated by systems provides basic data for fault detection and system monitoring. However, a traditional rule-based log analysis method only has limited detection capabilities and fails to handle multidimensional anomalies in high-frequency and complex environment.

In view of this, how to provide a more efficient and precise log anomaly detection system is a technical problem to be solved by those skilled in the art.

### SUMMARY

The present disclosure aims to provide an anomaly detection method. A log line of a target system may be detected through different anomaly detection operations, a pre-trained neural network model may be used to perform comprehensive detection on detection results obtained from different anomaly detection operations, more thorough and reliable comprehensive detection results are obtained, and multidimensional anomalies in high-frequency and complex environment may be handled.

To solve the above-mentioned technical problem, the present disclosure provides an anomaly detection system, including:
a plurality of markers, where the plurality of markers are different from each other and correspond to different anomaly detection operations, where the plurality of markers are configured to perform the anomaly detection operations on a log line generated by a target system within a preset time period to obtain anomaly scores, to convert the anomaly scores into discrete anomaly scores, and to add tokens for the respective anomaly detection operations to the discrete anomaly scores to obtain marker tokens; and
a model marker, configured to combine the marker tokens into a token sequence, and to perform anomaly detection on the token sequence by using a pre-trained neural network model to obtain an overall anomaly score of the target system within the preset time period, where whether the target system is abnormal is determined based on the overall anomaly score, where the pre-trained neural network model is trained with a preset baseline token sequence, and the overall anomaly score represents a degree to which the token sequence deviates from the baseline token sequence.

In an embodiment, the plurality of markers include:
a log sequence marker, configured to convert the log line into a log sequence, and to perform anomaly detection on the log sequence by using a pre-trained log sequence detection model to obtain a first anomaly score, where the pre-trained log sequence detection model is trained with a preset normal log sequence, and the first anomaly score represents a degree to which the log sequence deviates from the normal log sequence;
a log top field marker, configured to determine preset log top fields corresponding to the log line, to count an occurrence frequency of each preset log top field within the preset time period based on the log line to obtain log top field occurrence frequency distribution data at a current detection time, and to detect a variation degree of the log top field occurrence frequency distribution data at the current detection time relative to log top field occurrence frequency distribution data at a previous historical detection time to obtain a second anomaly score; and
a log structure marker, configured to update the log line to a log parsing tree, and to detect a variation degree of the log parsing tree at a current detection time relative to the log parsing tree at a previous historical detection time to obtain a third anomaly score.

In an embodiment, the plurality of markers include:
a histogram marker, configured to extract numerical values from the log line, to convert the extracted numerical values into a histogram, and to detect a variation degree of the histogram at a current detection time relative to the histogram at a previous historical detection time to obtain a fourth anomaly score;
a log rate marker, configured to extract numerical values from the log line, to fit the extracted numerical values into a line chart, to determine an outlier determination numerical interval based on the line chart, and to obtain a fifth anomaly score based on a ratio of numerical values outside the outlier determination numerical interval to all numerical values;
a numeric marker, configured to extract numerical values from the log line, to perform clustering processing on the extracted numerical values to obtain a numerical cluster, and to calculate a deviation degree of numerical values outside the numerical cluster relative to the numerical cluster to obtain a sixth anomaly score; and
a discrete marker, configured to extract a discrete variable from the log line, to count an occurrence frequency of each value corresponding to the discrete variable based on the extracted discrete variable to obtain discrete value occurrence frequency distribution data at a current detection time, and to detect a variation degree of the discrete value occurrence frequency distribution data at the current detection time relative to discrete value occurrence frequency distribution data at a previous historical detection time to obtain a seventh anomaly score.

In an embodiment, each marker of the plurality of markers is further configured to:
perform normalization on the anomaly scores; and
discretize the normalized anomaly scores to obtain discrete anomaly scores.

In an embodiment, the anomaly detection system further includes:
a log conversion marker, configured to convert the log line generated by the target system within the preset time period into log tokens,
where the model marker is further configured to combine the marker tokens and the log tokens into a token sequence.

In an embodiment, the model marker is further configured to:
mask part of the marker tokens in the token sequence to obtain a to-be-processed token sequence including masked marker tokens and unmasked marker tokens;
input the to-be-processed token sequence into the pre-trained neural network model, and perform, by using the pre-trained neural network model, prediction on the masked marker tokens in the to-be-processed token sequence based on the unmasked marker tokens in the to-be-processed token sequence to obtain predicted tokens; and
calculate a loss between the predicted tokens and the masked marker tokens in the to-be-processed token sequence by using a preset loss function and determine the loss as the overall anomaly score.

In an embodiment, the model marker is further configured to:
obtain the baseline token sequence;
mask part of tokens in the baseline token sequence to obtain a training token sequence including masked tokens and unmasked tokens;
input the training token sequence into an initial neural network model, and perform, by using the initial neural network model, prediction on the masked tokens in the training token sequence based on the unmasked tokens in the training token sequence to obtain to-be-compared tokens; and
calculate a loss between the to-be-compared tokens and the masked tokens in the training token sequence by using the preset loss function and perform parameter update on the initial neural network model based on the calculated loss to obtain the pre-trained neural network model.

The present disclosure further provides an anomaly detection method applied to the above-mentioned anomaly detection system, including:
performing, by the plurality of markers, the anomaly detection operations on a log line generated by a target system within a preset time period to obtain the anomaly scores, converting, by the plurality of markers, the anomaly scores into the discrete anomaly scores, and adding, by the plurality of markers, tokens corresponding to the respective anomaly detection operations to the discrete anomaly scores to obtain the marker tokens, where the plurality of markers are different from each other and correspond to different anomaly detection operations; and
combining, by the model marker, the marker tokens into a token sequence, and performing, by the model marker, anomaly detection on the token sequence by using a pre-trained neural network model to obtain an overall anomaly score of the target system within the preset time period, where whether the target system is abnormal is determined based on the overall anomaly score, where the pre-trained neural network model is trained with a preset baseline token sequence, and the overall anomaly score represents a degree to which the token sequence deviates from the baseline token sequence.

The present disclosure further provides an electronic device, including:
a memory, configured to store a computer program; and
a processor, configured to implement the above-mentioned anomaly detection method when executing the computer program.

The present disclosure further provides a computer-readable storage medium, where a computer-executable instruction is stored in the computer-readable storage medium, and the computer-executable instruction, when being loaded and executed by a processor, causes the processor to implement the above-mentioned anomaly detection method.

The anomaly detection system provided by the present disclosure primarily includes the plurality of markers, where the plurality of markers are different from each other and correspond to different anomaly detection operations. The plurality of markers are configured to perform the anomaly detection operations on the log line generated by the target system within the preset time period to obtain the anomaly scores, to convert the anomaly scores into the discrete anomaly scores, and to add tokens for the respective anomaly detection operations to the discrete anomaly scores to obtain marker tokens. That is, the log line of the target system may be detected from different dimensions by using the plurality of markers. In addition, the system further includes the model marker, where the model marker is configured to combine the marker tokens into a token sequence, and to perform anomaly detection on the token sequence by using a pre-trained neural network model to obtain an overall anomaly score of the target system within the preset time period, where whether the target system is abnormal is determined based on the overall anomaly score, where the pre-trained neural network model is trained with a preset baseline token sequence, and the overall anomaly score represents a degree to which the token sequence deviates from the baseline token sequence.

### BRIEF DESCRIPTION OF THE DRAWINGS

In order to illustrate the technical solutions in the embodiments of the present disclosure or the prior art more clearly, drawings used for description of the embodiments or the related art would be introduced below briefly. The drawings described below only show some embodiments of the present disclosure. Those of ordinary skill in the art may also obtain other drawings based on those drawings without creative work.

FIG. 1 is a structural block diagram of an anomaly detection system according to an embodiment of the present disclosure;

FIG. 2 is a structural block diagram of another anomaly detection system according to an embodiment of the present disclosure;

FIG. 3 is a schematic diagram of token sequence processing according to an embodiment of the present disclosure;

FIG. 4 is a flowchart of an anomaly detection method according to an embodiment of the present disclosure; and

FIG. 5 is a structural block diagram of an electronic device according to an embodiment of the present disclosure.

### DETAILED DESCRIPTION OF THE EMBODIMENTS

The technical solutions of the embodiments of the present disclosure would be described clearly and completely as follows in combination with the drawings of these embodiments for a clear understanding of the purposes, technical solutions and advantages of the present disclosure. The embodiments described are only some, not all of the embodiments of the present disclosure. All other embodiments obtained by those of ordinary skill in the art without creative work based on the embodiments of the present disclosure are within the scope of protection of the present disclosure.

In modern massive-scale computing environment, the vast amount of logs generated by systems provides basic data for fault detection and system monitoring. However, a traditional rule-based log analysis method only has limited detection capabilities and fails to handle multidimensional anomalies in high-frequency and complex environment.

In view of this, to overcome the technical problem of how to provide a more efficient and precise log anomaly detection system, the present disclosure provides an anomaly detection system. A log line of a target system may be detected through different anomaly detection operations, a pre-trained neural network model may be used to perform comprehensive detection on detection results obtained from different anomaly detection operations, more thorough and reliable comprehensive detection results are obtained, and multidimensional anomalies in high-frequency and complex environment may be handled.

For the sake of understanding, referring to FIG. 1, which is a structural block diagram of an anomaly detection system according to an embodiment of the present disclosure. The system may include a plurality of markers 10 and a single model marker 20, where the plurality of markers 10 are connected to the model marker 20, and the model marker 20 includes a pre-trained neural network model 21. Specific functions of the plurality of markers 10 and the model marker 20 are as follows.

The plurality of markers 10 are different from each other and correspond to different anomaly detection operations, where the plurality of markers are configured to perform the anomaly detection operations on a log line generated by a target system within a preset time period to obtain anomaly scores, to convert the anomaly scores into discrete anomaly scores, and to add tokens for the respective anomaly detection operations to the discrete anomaly scores to obtain marker tokens.

The model marker 20 is configured to combine the marker tokens into a token sequence, and to perform anomaly detection on the token sequence by using a pre-trained neural network model 21 to obtain an overall anomaly score of the target system within the preset time period, where whether the target system is abnormal is determined based on the overall anomaly score, where the pre-trained neural network model 21 is trained with a preset baseline token sequence, and the overall anomaly score represents a degree to which the token sequence deviates from the baseline token sequence.

The above-mentioned target system refers to a system monitored by the anomaly detection system, which may be any system capable of generating logs, such as a network system or an Internet of Things (IoT) system. The processed log line may be a network traffic log or an IoT device log. In addition, in this embodiment, the specific implementation of detecting the log line generated by the target system within the preset time period by using the anomaly detection system may be detecting the log line generated by the target system within a specified time period by using the anomaly detection system, or may be periodical detecting the log line generated by the target system every periodic interval by using the anomaly detection system. For example, the log line generated by the target system within 10 minutes is detected every 10 minutes, or the log line generated by the target system with one today is detected once a day.

In this embodiment, the log line generated by the target system within the preset time period is firstly input to different markers 10, where the different markers 10 perform different anomaly detection operations for detection, to perform preliminary anomaly detection on the target system from different perspectives and dimensions. The anomaly score herein represent an anomaly situation of the target system in a single dimension. A higher anomaly score indicates a more severe anomaly, and a lower anomaly score indicates a milder anomaly. After obtaining the anomaly scores, for the convenience of subsequent model processing, the plurality of markers 10 may further convert the anomaly scores into the discrete anomaly scores and add the tokens for the respective anomaly detection operations to the discrete anomaly scores to obtain the marker tokens. This embodiment is not intended to limit specific anomaly detection operations, and reference may be made to description in subsequent embodiments. For example, based on types of the anomaly detection operations, the plurality of markers 10 may be divided into seven types, namely, a log sequence marker, a log top field marker, a log structure marker, a histogram marker, a log rate marker, a numeric marker and a discrete marker. Specific functions of the seven markers may be referenced in subsequent embodiments. This embodiment does not limit the method for converting the anomaly scores into the discrete anomaly scores. For example, if the anomaly scores are within the range from 0 to 10, a plurality of intervals may be set at a spacing of 1, namely, 0-1, 1-2, 2-3 and so on, and then the anomaly scores may be converted into the discrete anomaly scores based on corresponding intervals. For example, an anomaly score being 1.1 may be converted into a discrete anomaly score being 2. This embodiment does not limit the token for each anomaly detection operation, as long as each anomaly detection operation corresponding to a different token.

Furthermore, for a marker token generated by each marker of the plurality of markers 10, the model marker 20 may combine the marker tokens into a token sequence and perform anomaly detection on the token sequence by using the pre-trained neural network model 21 to obtain the overall anomaly score of the target system within the preset time period. The pre-trained neural network model 21 is trained with the preset baseline token sequence. For example, in this embodiment, the log line generated by the target system under normal conditions may be collected in advance, and a certain number of baseline token sequences may be generated based on the log line. The pre-trained neural network model 21 may be controlled to be trained with the baseline token sequences in the subsequent. Moreover, the overall anomaly score represents a degree to which the token sequence deviates from the baseline token sequences. That is, the pre-trained neural network model 21 may quantify a degree to which the target system deviates from a baseline condition based on the baseline token sequences, where the pre-trained neural network model 21 has been trained with the baseline token sequences, to determine an overall condition of the target system.

The plurality of markers 10 focus on anomalies of the target system from single dimensions, the model marker 20 focuses on an anomaly of the target system from a global dimension and combining the plurality of markers 10 and the model marker 20 may avoid misjudgment caused by the single dimensions. In an embodiment, in case that one or more anomaly scores from single dimensions are relatively high consistently during normal operation of the target system, and the relatively high anomaly scores have been recorded in the baseline token sequence, the relatively high anomaly scores would be identified as an anomaly by the relatively high markers 10, and would be identified as a baseline condition rather than anomalies by the model marker 20. For example, for a network system, in case that the system frequently experiences a surge in visits within specified periods, and the surge in visits is identified as a normal phenomenon by an operator, the surge in visits would be identified as an anomaly by the markers 10 having a surge in detection visits, and would be identified as a normal phenomenon by the model marker 20. Only providing the markers 10 would cause false alarms. In this embodiment, the model marker 20 is added, and such false alarms are avoided. It can be seen that this embodiment enables more comprehensive and reliable log anomaly detection, and multidimensional anomalies in high-frequency and complex environment may be handled.

Furthermore, since the anomaly scores output from different markers may have correlations, to facilitate the model in identifying the correlations between anomaly scores of various detection types, the marker tokens respectively corresponding to each anomaly detection type may sequentially form the token sequence, so that the model may learn and identify the correlations between the marker tokens. The anomaly detection type refers to a type of the anomaly detection operation.

Furthermore, to facilitate association in model analysis of the anomaly scores between the markers, the plurality of markers 10 may perform normalization on the anomaly scores before discretization.

Based on this, each marker 10 of the plurality of markers 10 may be further configured to:
perform normalization on the anomaly scores; and
discretize the normalized anomaly scores to obtain discrete anomaly scores.

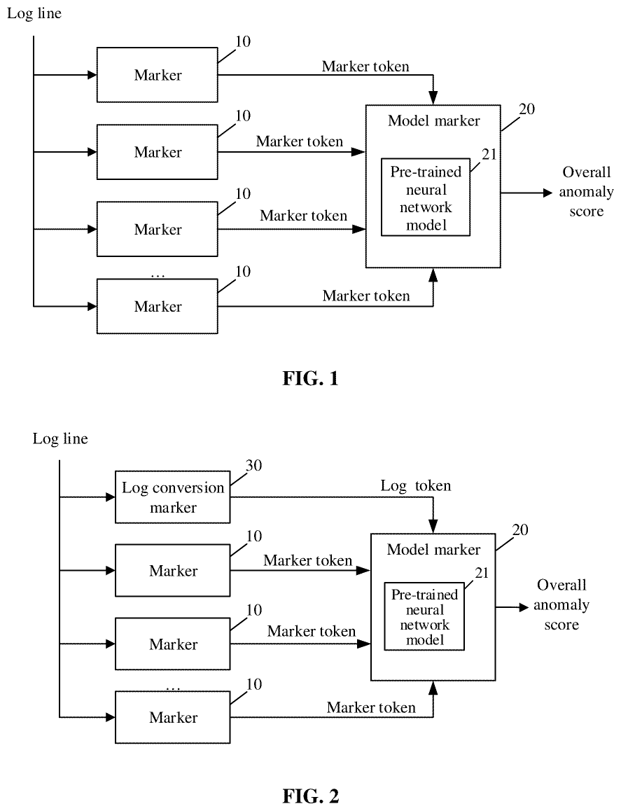

Furthermore, in addition to performing model detection on the marker token output by each marker 10, the model marker 20 may also perform model detection in combination with the content of the log line. In an embodiment, referring to FIG. 2, which is a structural block diagram of another anomaly detection system according to an embodiment of the present disclosure, the system may further include a log conversion marker 30. The log conversion marker 30 is configured to convert the log line generated by the target system within the preset time period into the log token. In this case, the model marker 20 may be further configured to combine the marker tokens and the log tokens into a token sequence, to input the token sequence including the marker tokens and the log tokens to the pre-trained neural network model for processing.

This embodiment is not intended to limit how the log conversion marker 30 converts the log line into the log tokens, as long as a small number of token identifiers may represent the complete log line, and the small number of token identifiers are determined as the log tokens. For example, a DRAIN algorithm may be used to parse the log line, and convert the log line into the log tokens, to determine the log tokens as the log token. The DRAIN algorithm is a fixed-depth tree-based online log parsing method.

Based on the above-mentioned embodiment, the anomaly detection system provided by the present disclosure primarily includes the plurality of markers, where the plurality of markers are different from each other and correspond to different anomaly detection operations. The plurality of markers are configured to perform the anomaly detection operations on the log line generated by the target system within the preset time period to obtain the anomaly scores, to convert the anomaly scores into the discrete anomaly scores, and to add tokens for the respective anomaly detection operations to the discrete anomaly scores to obtain marker tokens. That is, the log line of the target system may be detected from different dimensions by using the plurality of markers. In addition, the system further includes the model marker, where the model marker is configured to combine the marker tokens into a token sequence, and to perform anomaly detection on the token sequence by using a pre-trained neural network model to obtain an overall anomaly score of the target system within the preset time period, where whether the target system is abnormal is determined based on the overall anomaly score, where the pre-trained neural network model is trained with a preset baseline token sequence, and the overall anomaly score represents a degree to which the token sequence deviates from the baseline token sequence. That is, comprehensive detection may be performed on detection results of different markers by using the pre-trained neural network model, more thorough and reliable comprehensive detection results are obtained, and multidimensional anomalies in high-frequency and complex environment may be handled.

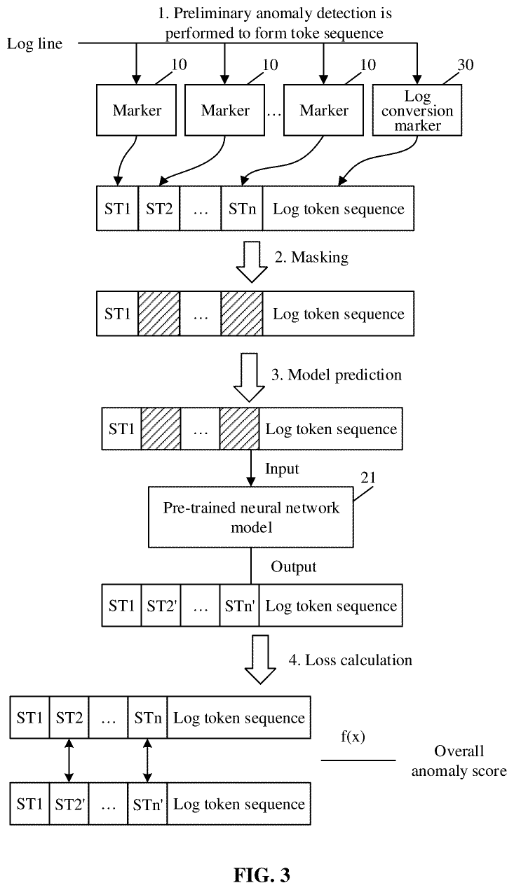

Based on the above-mentioned embodiment, a specific procedure of processing the token sequence by using the model marker 20 is described as follows. For the sake of understanding, referring to FIG. 3, which is a schematic diagram of token sequence processing according to an embodiment of the present disclosure. In an embodiment, the model marker 20 may be further configured to:
mask part of the marker tokens in the token sequence to obtain a to-be-processed token sequence including masked marker tokens and unmasked marker tokens;
input the to-be-processed token sequence into the pre-trained neural network model 21, and perform, by using the pre-trained neural network model 21, prediction on the masked marker tokens in the to-be-processed token sequence based on the unmasked marker tokens in the to-be-processed token sequence to obtain predicted tokens; and
calculate a loss between the predicted tokens and the masked marker tokens in the to-Be-processed

Token sequence by using a preset loss function and determine the loss as the overall anomaly score.

As shown in FIG. 3, a processing procedure of the overall anomaly score may include the following step 1 to step 4. In step 1, the log line is input into each marker 10 of the plurality of markers 10 and the log conversion marker 30 for preliminary anomaly detection and processing, and the token sequence may sequentially consist of the marker tokens generated by the plurality of markers 10 and the log tokens generated by the log conversion marker 30.

In step 2, part of the marker tokens in the token sequence are masked to obtain a to-be-processed token sequence including masked marker tokens and unmasked marker tokens. In an embodiment, tokens may be randomly selected from the marker tokens and the log tokens for masking. In FIG. 3, portions covered by slashes represent the masked marker tokens, and portions not covered by slashes represent the unmasked marker tokens. For illustrative convenience, only the marker tokens are covered in FIG. 3. In practical applications, log tokens in a log token sequence may also be masked.

In step 3, the to-be-processed token sequence is input into the pre-trained neural network model 21 to obtain predicted tokens output from the pre-trained neural network model 21. In FIG. 3, ST2′ and STn′ represent the predicted tokens corresponding to the masked marker token. The pre-trained neural network model 21 is required to predict the masked marker tokens in the to-be-processed token sequence based on the baseline token sequence and the unmasked marker tokens in the to-be-processed token sequence, where the pre-trained neural network model 21 has been trained with the baseline token sequences. In brief, the pre-trained neural network model 21 is required to perform data imputation on the masked marker tokens in the to-be-processed token sequence based on a baseline condition.

In step 4, a loss between the predicted tokens and the masked marker tokens in the to-be-processed token sequence is calculated by using a preset loss function, and the loss is determined as the overall anomaly score. In FIG. 3, f(x) represents a preset loss function. After the predicted tokens respectively corresponding to each masked marker token are obtained, considering that the token sequence may correspond to a condition deviating from the baseline condition, that is, the masked marker tokens may differ from the predicted tokens, in this embodiment, the preset loss function may be used to calculate the loss between the predicted tokens and the masked marker tokens in the to-be-processed token sequence, and the loss is determined as the overall anomaly score. The loss represents the difference between the masked marker tokens and the predicted tokens, to represents the difference between the condition corresponding to the token sequence and the baseline condition. Therefore, in this embodiment, overall detection of the target system may be finished.

This embodiment is not intended to limit a specific pre-trained neural network model 21, as long as the model belongs to masked language models (MLMs). For example, the pre-trained language model may be a bidirectional encoder representations from transformers (BERT) model. This embodiment is not intended to limit a procedure of processing the token sequence by using the pre-trained detection model, and reference may be made to related technologies for a BERT model. The pre-trained detection model may first perform positional encoding on each marker token in the to-be-processed token sequence to obtain an encoded vector, identify the function of each marker token in the to-be-processed token sequence and correlations between the marker tokens based on the encoded vectors, and then predict the masked marker tokens.

This embodiment is not intended to limit a specific preset loss function. The loss function used during model training may be determined as the preset loss function, and reference may be made to related technologies for training a MLM model.

A procedure of training the pre-trained neural network model 21 is described in the following. Based on this, the model marker may be further configured to:
obtain the baseline token sequence;
mask part of tokens in the baseline token sequence to obtain a training token sequence including masked tokens and unmasked tokens;
input the training token sequence into an initial neural network model, and perform, by using the initial neural network model, prediction on the masked tokens in the training token sequence based on the unmasked tokens in the training token sequence to obtain to-be-compared tokens; and
calculate a loss between the to-be-compared tokens and the masked tokens in the training token sequence by using the preset loss function and perform parameter update on the initial neural network model based on the calculated loss to obtain the pre-trained neural network model 21.

Similar to the above-mentioned embodiment, in this embodiment, part of tokens in the baseline token sequence are required to be masked to obtain a training token sequence including the masked token and the unmasked token. Subsequently, the training token sequence may be input into the initial neural network mode. The initial neural network mode performs prediction on the masked tokens in the training token sequence based on the unmasked tokens in the training token sequence to obtain to-be-compared tokens. After the to-be-compared tokens respectively corresponding to each masked token are obtained, in this embodiment, the preset loss function may be used to calculate the loss between the to-be-compared tokens and the masked tokens in the training token sequence. Different from the above-mentioned embodiment, in this procedure, the initial neural network model is trained. Therefore, parameter update is required to be performed on the initial neural network model based on the loss, to obtain the pre-trained neural network model 21. The aforementioned training procedure may be repeated until the performance of the pre-trained neural network model 21 satisfies application requirements.

Based on the above-mentioned embodiment, various markers 10 are described as follows. In an embodiment, the plurality of markers 10 may include:
a log sequence marker, configured to convert the log line into a log sequence, and to perform anomaly detection on the log sequence by using a pre-trained log sequence detection model to obtain a first anomaly score, where the pre-trained log sequence detection model is trained with a preset normal log sequence, and the first anomaly score represents a degree to which the log sequence deviates from the normal log sequence.

In this embodiment, the log sequence marker is configured to detect the log sequence, and a core of the log sequence marker is the pre-trained log sequence detection model. The pre-trained log sequence detection model is trained with the preset normal log sequence. Therefore, the first anomaly score obtained by the pre-trained log sequence detection model performing anomaly detection on the log sequence may represent the degree to which the log sequence deviates from the normal log sequence. Therefore, in this embodiment, anomalies in the log sequence may be detected in a timely manner.

This embodiment is not intended to limit a specific type of the pre-trained log sequence detection model. For example, it may be a log BERT model.

### In an embodiment, the plurality of markers 10 may include:

a log top field marker, configured to determine preset log top fields corresponding to the log line, to count an occurrence frequency of each preset log top field within the preset time period based on the log line to obtain log top field occurrence frequency distribution data at a current detection time, and to detect a variation degree of the log top field occurrence frequency distribution data at the current detection time relative to log top field occurrence frequency distribution data at a previous historical detection time to obtain a second anomaly score.

In this embodiment, the log top field marker is configured to detect a frequency change of each preset log top field and quantify the frequency change as the second anomaly score. In an embodiment, the log top field marker may determine preset log top fields corresponding to each log line generated within the preset time period and count an occurrence frequency of each preset log top field within a current preset time period, to obtain the log top field occurrence frequency distribution data at the current detection time. Subsequently, the log top field marker may obtain the log top field occurrence frequency distribution data at a previous historical detection time, determine a variation degree of the log top field occurrence frequency distribution data at the current detection time relative to the log top field occurrence frequency distribution data at the previous historical detection time, and determine the variation degree as the second anomaly score. Therefore, in this embodiment, abrupt changes in the log top fields may be detected in a timely manner.

This embodiment is not intended to limit specific preset log top fields, and the preset log top field may be set based on actual application requirements. This embodiment is not intended to limit how to calculate a variation degree between log top field occurrence frequency distribution data at different times. For example, a Jensen-Shannon drift divergence (JSD) algorithm may be adopted for calculation.

In an embodiment, the plurality of markers 10 may include:
a log structure marker, configured to update the log line to a log parsing tree, and to detect a variation degree of the log parsing tree at a current detection time relative to the log parsing tree at a previous historical detection time to obtain a third anomaly score.

In this embodiment, the log structure marker is configured to detect variation of the log parsing tree at different times. In an embodiment, the log structure marker may update the log line to the log parsing tree and detect the variation degree of the log parsing tree at the current detection time relative to the log parsing tree at the previous historical detection time, to obtain the third anomaly score. The log parsing tree is a multi-level hierarchical structure constructed based on the log line and is configured for log parsing. The log parsing tree may be generated by using a DRAIN algorithm. For specific generation methods, reference may be made to related technologies about a DRAIN algorithm. Therefore, in this embodiment, abrupt changes in the log parsing tree may be detected in a timely manner.

This embodiment is not intended to limit how to calculate a variation degree between log parsing trees at different times. For example, the above-mentioned JSD algorithm may also be adopted for calculation.

The aforementioned three markers mainly detect the sequence, the field and the structure of the log line. The markers 10 configured for detecting numerical values in the log line are described in the following. In an embodiment, the plurality of markers 10 may include:
a histogram marker, configured to extract numerical values from the log line, to convert the extracted numerical values into a histogram, and to detect a variation degree of the histogram at a current detection time relative to the histogram at a previous historical detection time to obtain a fourth anomaly score.

In this embodiment, for cumulative numerical values, the histogram marker may convert them into the histogram and detect the variation degree of the histogram at the current detection time relative to the histogram at the previous historical detection time to obtain the fourth anomaly score. Therefore, in this embodiment, abrupt changes in the histogram may be detected in a timely manner.

This embodiment is not intended to limit how to calculate a variation degree between histograms. For example, the above-mentioned JSD algorithm may also be adopted for calculation.

In an embodiment, the plurality of markers 10 may include:
a log rate marker, configured to extract numerical values from the log line, to fit the extracted numerical values into a line chart, to determine an outlier determination numerical interval based on the line chart, and to obtain a fifth anomaly score based on a ratio of numerical values outside the outlier determination numerical interval to all numerical values.

In this embodiment, for fluctuating numerical values, the log rate marker may fit them into the line chart, to reflect fluctuations of the fluctuating numerical values over time. Subsequently, the log rate marker may determine an outlier determination numerical interval based on the line chart. The outlier determination numerical interval is a numerical interval used for determining outliers. For example, numerical values within the interval are non-outliers, and numerical values outside the interval are outliers. In brief, the outlier determination numerical interval is used for determining numerical values with abnormal fluctuation amplitudes. Finally, the log rate marker may obtain the fifth anomaly score based on the ratio of numerical values outside the outlier determination numerical interval to all numerical values. Therefore, in this embodiment, abnormal fluctuations of the fluctuating numerical values may be determined.

The outlier determination numerical interval may be constructed through various methods. For example, the outlier determination numerical interval may be constructed based on a prediction interval algorithm (e.g., a Facebook Prophet algorithm). The outlier determination numerical interval may also be obtained by perform standard deviation calculation on the numerical values consisting the line chart and determining a preset multiple of a standard deviation as an upper/lower limit of the outlier determination numerical interval.

In an embodiment, the plurality of markers 10 may include:
a numeric marker, configured to extract numerical values from the log line, to perform clustering processing on the extracted numerical values to obtain a numerical cluster, and to calculate a deviation degree of numerical values outside the numerical cluster relative to the numerical cluster to obtain a sixth anomaly score.

In this embodiment, the numeric marker may perform clustering detection on the numerical values and detect outlier situations based on the numerical cluster obtained by clustering, such as calculating the deviation degree of numerical values outside the numerical cluster relative to the numerical cluster to obtain the sixth anomaly score. Therefore, in this embodiment, abnormal outlier situations among the numerical values may be detected in a timely manner.

This embodiment is not intended to limit how to perform clustering processing on numerical values. Related technologies in clustering algorithms, such as a density-based spatial clustering of applications with noise (DBSCAN) algorithm, may be adopted for clustering processing.

### In an embodiment, the plurality of markers 10 may include:

a discrete marker, configured to extract a discrete variable from the log line, to count an occurrence frequency of each value corresponding to the discrete variable based on the extracted discrete variable to obtain discrete value occurrence frequency distribution data at a current detection time, and to detect a variation degree of the discrete value occurrence frequency distribution data at the current detection time relative to discrete value occurrence frequency distribution data at a previous historical detection time to obtain a seventh anomaly score.

In this embodiment, the discrete variable refers to a variable having a plurality of preset values. The target system would select a value for the discrete variable from the plurality of preset values. For such numerical values, the discrete marker may count the occurrence frequency of each value corresponding to the discrete variable to obtain discrete value occurrence frequency distribution data at the current detection time, and detect the variation degree of the discrete value occurrence frequency distribution data at the current detection time relative to the discrete value occurrence frequency distribution data at the previous historical detection time to obtain the seventh anomaly score. Therefore, in this embodiment, anomalies in the value of the discrete variable may be detected in a timely manner.

This embodiment is not intended to limit how to calculate a variation degree between discrete value occurrence frequency distribution data. For example, the above-mentioned JSD algorithm may also be adopted for calculation.

Finally, this embodiment is not intended to limit types or specific anomaly detection operations of the markers. In addition to the aforementioned markers, other markers may be added as required.

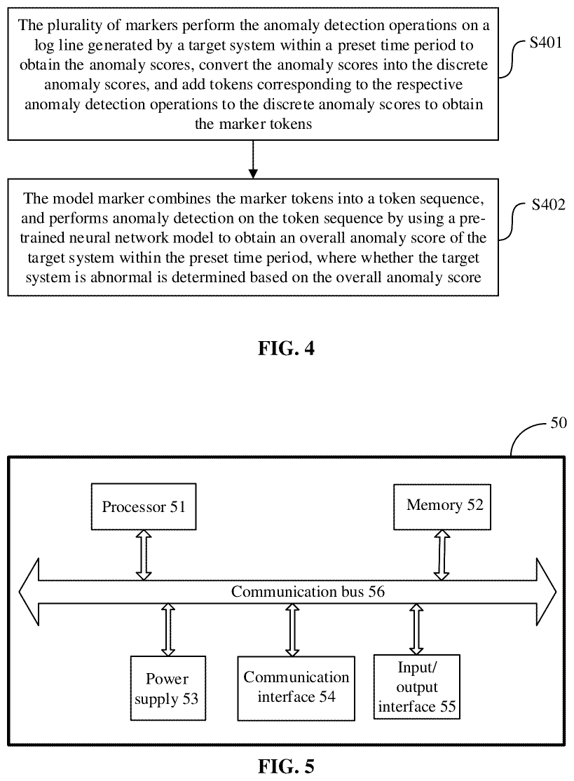

Based on the above-mentioned embodiments, an anomaly detection method according to an embodiment of the present disclosure is described as follows. Referring to FIG. 4, which is a flowchart of an anomaly detection method according to an embodiment of the present disclosure. The method is applied to the above-mentioned anomaly detection system and may include the following steps.

In S401, the plurality of markers perform the anomaly detection operations on a log line generated by a target system within a preset time period to obtain the anomaly scores, convert the anomaly scores into the discrete anomaly scores, and add tokens corresponding to the respective anomaly detection operations to the discrete anomaly scores to obtain the marker tokens, where the plurality of markers are different from each other and correspond to different anomaly detection operations.

In this step, the log line generated by the target system within the preset time period is firstly input to different markers 10, where the different markers 10 perform different anomaly detection operations for detection, to perform preliminary anomaly detection on the target system from different perspectives and dimensions. After obtaining the anomaly scores, for the convenience of subsequent model processing, the plurality of markers 10 may further convert the anomaly scores into the discrete anomaly scores and add the tokens for the respective anomaly detection operations to the discrete anomaly scores to obtain the marker tokens.

Furthermore, to facilitate association in model analysis of the anomaly scores between the markers, the plurality of markers 10 may perform normalization on the anomaly scores before discretization.

In an embodiment, the method may further include step 11 and step 12.

In S11, each marker 10 of the plurality of markers 10 performs normalization on the anomaly scores.

In S12, each marker 10 of the plurality of markers 10 discretizes the normalized anomaly scores to obtain the discrete anomaly scores.

In S402, the model marker combines the marker tokens into a token sequence, and performs anomaly detection on the token sequence by using a pre-trained neural network model to obtain an overall anomaly score of the target system within the preset time period, where whether the target system is abnormal is determined based on the overall anomaly score, where the pre-trained neural network model is trained with a preset baseline token sequence, and the overall anomaly score represents a degree to which the token sequence deviates from the baseline token sequence.

In this step, for a marker token generated by each marker of the plurality of markers 10, the model marker 20 may combine the marker tokens into a token sequence and perform anomaly detection on the token sequence by using the pre-trained neural network model 21 to obtain the overall anomaly score of the target system within the preset time period. The pre-trained neural network model 21 is trained with the preset baseline token sequence. Therefore, the pre-trained neural network model 21 may be used to detect the input token sequence to determine a degree to which the target system deviates from a baseline condition.

Furthermore, in addition to performing model detection on the marker token output by each marker 10, the model marker 20 may also perform model detection in combination with the content of the log line. Based on this, this method may further include step S21 and step S22.

In S21, the log conversion marker converts the log line generated by the target system within the preset time period into the log token.

In S22, the model marker combines the marker tokens and the log tokens into a token sequence.

How to detect the token sequence by using the model marker is described in the following. Based on this, the step in which the model marker combines the marker tokens into a token sequence and performs anomaly detection on the token sequence by using a pre-trained neural network model to obtain an overall anomaly score of the target system within the preset time period may include step S101 to step S103.

In S101, part of the marker tokens in the token sequence are masked to obtain the to-be-processed token sequence including the masked marker token and the unmasked marker token.

In S102, the to-be-processed token sequence is input into the pre-trained neural network model, and prediction is performed, by using the pre-trained neural network model, on the masked marker tokens in the to-be-processed token sequence based on the unmasked marker tokens in the training token sequence to obtain predicted tokens.

In S103, a loss between the predicted tokens and the masked marker tokens in the to-be-processed token sequence is calculated by using a preset loss function, and the loss is determined as the overall anomaly score.

In this embodiment, firstly, the token sequence may sequentially consist of the marker tokens generated by the plurality of markers 10 and the log tokens generated by the log conversion marker 30. Secondly, in this embodiment, part of the marker tokens in the token sequence is masked to obtain a to-be-processed token sequence including masked marker tokens and unmasked marker tokens. Thirdly, the to-be-processed token sequence is input into the pre-trained neural network model 21. The pre-trained neural network model 21 is required to predict the masked marker tokens in the to-be-processed token sequence based on the baseline token sequence and the unmasked marker tokens in the to-be-processed token sequence, where the pre-trained neural network model 21 has been trained with the baseline token sequences. In brief, the pre-trained neural network model 21 is required to perform data imputation on the masked marker tokens in the to-be-processed token sequence based on a baseline condition.

Finally, after the predicted tokens respectively corresponding to each masked marker token are obtained, a loss between the predicted tokens and the masked marker tokens in the to-be-processed token sequence is calculated by using a preset loss function, and the loss is determined as the overall anomaly score. The loss represents the difference between the masked marker tokens and the predicted tokens, to represents the difference between the condition corresponding to the token sequence and the baseline condition. Therefore, in this embodiment, overall detection of the target system may be finished.

A method for training the pre-trained neural network model is described in the following. Based on this, this method may further include step S201 to step S204.

In S201, the baseline token sequence is obtained.

In S202, part of the tokens in the baseline token sequence are masked to obtain a training token sequence including masked tokens and unmasked tokens.

In S203, the training token sequence is input into an initial neural network model, and prediction is performed, by using the initial neural network model, on the masked tokens in the training token sequence based on the unmasked tokens in the training token sequence to obtain to-be-compared tokens.

In S204, a loss between the to-be-compared tokens and the masked tokens in the training token sequence is calculated by using the preset loss function, and parameter update is performed on the initial neural network model based on the calculated loss to obtain the pre-trained neural network model.

Similar to the above-mentioned embodiment, in this embodiment, part of tokens in the baseline token sequence are required to be masked to obtain a training token sequence including the masked token and the unmasked token. Subsequently, the training token sequence may be input into the initial neural network mode. The initial neural network mode performs prediction on the masked tokens in the training token sequence based on the unmasked tokens in the training token sequence to obtain to-be-compared tokens. After the to-be-compared tokens respectively corresponding to each masked token are obtained, in this embodiment, the preset loss function may be used to calculate the loss between the to-be-compared tokens and the masked tokens in the training token sequence. Different from the above-mentioned embodiment, in this procedure, the initial neural network model is trained. Therefore, parameter update is required to be performed on the initial neural network model based on the loss, to obtain the pre-trained neural network model 21. The aforementioned training procedure may be repeated until the performance of the pre-trained neural network model 21 satisfies application requirements.

A specific method of the markers performing anomaly detection operations are described in the following.

In an embodiment, the step in which the plurality of markers perform the anomaly detection operations on a log line generated by a target system within a preset time period to obtain the anomaly scores may include step S31 and step S32.

In S31, the log line is converted into a log sequence.

In S32, anomaly detection is performed on the log sequence by using a pre-trained log sequence detection model to obtain a first anomaly score, where the pre-trained log sequence detection model is trained with a preset normal log sequence, and the first anomaly score represents a degree to which the log sequence deviates from the normal log sequence.

In this embodiment, the log sequence marker may detect the log sequence, to detect anomalies in the log sequence in a timely manner.

In an embodiment, the step in which the plurality of markers perform the anomaly detection operations on a log line generated by a target system within a preset time period to obtain the anomaly scores may further include step S41 and step S42.

In S41, preset log top fields corresponding to the log line are determined, and an occurrence frequency of each preset log top field within the preset time period is counted based on the log line to obtain log top field occurrence frequency distribution data at a current detection time.

In S42, a variation degree of the log top field occurrence frequency distribution data at the current detection time relative to log top field occurrence frequency distribution data at a previous historical detection time is detected to obtain a second anomaly score.

In this embodiment, the log top field marker may detect a frequency change of each of the preset log top fields, to detect abrupt changes in the log top fields in a timely manner.

In an embodiment, the step in which the plurality of markers perform the anomaly detection operations on a log line generated by a target system within a preset time period to obtain the anomaly scores may further include step S51 and step S52.

In S51, the log line is updated to a log parsing tree.

In S52, a variation degree of the log parsing tree at a current detection time relative to the log parsing tree at a previous historical detection time is detected to obtain a third anomaly score.

In this embodiment, the log structure marker may detect variation of the log parsing tree at different times, to detect abrupt changes in the log parsing tree in a timely manner.

In an embodiment, the step in which the plurality of markers perform the anomaly detection operations on a log line generated by a target system within a preset time period to obtain the anomaly scores may further include step S61 and step S62.

In S61, numerical values are extracted from the log line, and the extracted numerical values are converted into a histogram.

In S62, a variation degree of the histogram at a current detection time relative to the histogram at a previous historical detection time is detected to obtain a fourth anomaly score.

In this embodiment, for cumulative numerical values, the histogram marker may be configured to convert them into the histogram and detect the variation degree of the histograms at different detection times, to detect abrupt changes in the histograms.

In an embodiment, the step in which the plurality of markers perform the anomaly detection operations on a log line generated by a target system within a preset time period to obtain the anomaly scores may further include step S71 to step S73.

In S71, numerical values are extracted from the log line, and the extracted numerical values are fitted into a line chart.

In S72, an outlier determination numerical interval is determined based on the line chart.

In S73, a fifth anomaly score is obtained based on a ratio of numerical values outside the outlier determination numerical interval to all numerical values.

In this embodiment, for fluctuating numerical values, the log rate marker may be configured to fit them into the line chart and determine an outlier determination numerical interval based on the line chart, to detect abnormal fluctuations of the fluctuating numerical values in a timely manner.

In an embodiment, the step in which the plurality of markers perform the anomaly detection operations on a log line generated by a target system within a preset time period to obtain the anomaly scores may further include step S81 and step S82.

In S81, numerical values are extracted from the log line.

In S82, clustering processing is performed on the extracted numerical values to obtain a numerical cluster.

In S83, a deviation degree of numerical values outside the numerical cluster relative to the numerical cluster is calculated to obtain a sixth anomaly score.

In this embodiment, the numeric marker may perform clustering detection on the numerical values and detect outlier situations based on the data cluster obtained by clustering, to detect abnormal outlier situations among the numerical values in a timely manner.

In an embodiment, the step in which the plurality of markers perform the anomaly detection operations on a log line generated by a target system within a preset time period to obtain the anomaly scores may further include step S91 to step S93.

In S91, a discrete variable is extracted from the log line.

In S92, an occurrence frequency of each value corresponding to the discrete variable is counted based on the extracted discrete variable to obtain discrete value occurrence frequency distribution data at a current detection time.

In S93, a variation degree of the discrete value occurrence frequency distribution data at the current detection time relative to discrete value occurrence frequency distribution data at a previous historical detection time is detected to obtain a seventh anomaly score.

In this embodiment, the discrete variable refers to a variable having a plurality of preset values. For such numerical values, the discrete marker may be configured to count an occurrence frequency of each value corresponding to the discrete variable and detect a variation degree of the discrete value occurrence frequency distribution data at different detection times, to detect abnormal changes in the value of the discrete variable in a timely manner.

Referring to FIG. 5, which is a structural block diagram of an electronic device according to an embodiment of the present disclosure. The embodiment of the present disclosure provides an electronic device 50, including a processor 51 and a memory 52. The memory 52 is configured to store a computer program, and the processor 51 is configured to implement the anomaly detection method according to the above-mentioned embodiment when executing the computer program.

A specific procedure of the aforementioned anomaly detection method may be referred to the corresponding content provided in the above embodiments, which are not described here.

Moreover, the memory 52, as a carrier for resource storage, may be a read-only memory (ROM), a random access memory (RAM), a disk, an optical disk and the like, and its storage modes include temporary storage or permanent storage.

In addition, the electronic device 50 further includes a power supply 53, a communication interface 54, an input/output interface 55, and a communication bus 56. The power supply 53 is used to provide operation voltage for each hardware device on the electronic device 50. The communication interface 54 may create a data transmission channel between the electronic device 50 and an external device and follows any communication protocol applicable to the technical solutions of the present disclosure, which is not specifically limited here. The input/output interface 55 is used to obtain input data or output data, and its specific interface type may be selected based on specific application requirements, which is not specifically limited here.

Furthermore, a plurality of the electronic devices may also be clustered to jointly implement the aforementioned anomaly detection method. For example, part of the electronic devices are provided with a marker configured to perform anomaly detection operations, and another part of the electronic devices are provided with a model marker configured to perform model detection on a token sequence.

An embodiment of the present disclosure further provides a computer program product including a computer program/an instruction, where when executed by a processor, the computer program/the instruction causes the processor to implement the anomaly detection method as described in the above embodiment.

Since the embodiments related to the computer program product correspond to those related to the anomaly detection method, the description of the anomaly detection method-related embodiments may be referred to the description of the computer program product-related embodiments, which are not described here.

An embodiment of the present disclosure further provides a computer-readable storage medium having a computer program stored thereon, where when executed by a processor, the computer program causes the processor to implement the anomaly detection method as described in the above embodiment.

Since the embodiments related to the computer-readable storage medium correspond to those related to the anomaly detection method, the description of the anomaly detection method-related embodiments may be referred to the description of the computer-readable storage medium-related embodiments, which are not described here.

The embodiments in the description have been described in a progressive manner. What are emphasized in each embodiment refer to the differences from other embodiments. The same or similar parts among the embodiments may be referred to each other. For the devices disclosed in the embodiments, the descriptions are relatively brief as they correspond to the methods disclosed in the embodiments. Reference may be made to the description of the methods for relevant features.

Further, those skilled in the art can understand that the technical solutions can be realized by an electronic hardware, a computer software or a combination thereof in conjunction with various exemplary units and algorithm steps described in the embodiments of the present disclosure. To clearly illustrate the interchangeability of the hardware and the software, compositions and steps of each example have been generally described above based on functions. Whether these functions are implemented by a software or a hardware depends on the specific application of the technical solution and design constraints. Those skilled in the art can also implement the described function for each specific application in various ways. However, this implementation should not be interpreted as deviating from the scope of the present disclosure.

The technical solutions can be directly implemented in the form of a hardware, a software module performed by the processor or a combination thereof in conjunction with the methods or algorithm steps described in the embodiments of the present disclosure. The software module can be provided in an RAM, an internal storage, an ROM, an electrically programmable ROM, an EEPROM, a register, a hard disk, a removable disk, a CD-ROM or a storage medium in any other forms known in the art.

The above is detailed description for the anomaly detection system, the anomaly detection method, the electronic device and the storage medium provided by the present disclosure. Specific embodiments are taken to describe the principles and implementations of the present disclosure, and the above description of embodiments only intends to facilitate in understanding the methods and basic idea of the present disclosure. For those of skills in the art, various alternations and modifications can be made to the present disclosure without departing from the principles thereof, and these alternations and modifications also fall within the scope of protection of the present disclosure.

1. An anomaly detection system, comprising:
a plurality of markers, wherein the plurality of markers are different from each other and correspond to different anomaly detection operations, wherein the plurality of markers are configured to perform the anomaly detection operations on a log line generated by a target system within a preset time period to obtain anomaly scores, to convert the anomaly scores into discrete anomaly scores, and to add tokens for the respective anomaly detection operations to the discrete anomaly scores to obtain marker tokens; and
a model marker, configured to combine the marker tokens into a token sequence, and to perform a token sequence anomaly detection on the token sequence by using a pre-trained neural network model to obtain an overall anomaly score of the target system within the preset time period, wherein whether the target system is abnormal is determined based on the overall anomaly score, wherein the pre-trained neural network model is trained with a preset baseline token sequence, and the overall anomaly score represents a degree to which the token sequence deviates from the baseline token sequence.

2. The anomaly detection system according to claim 1, wherein the plurality of markers comprise:
a log sequence marker, configured to convert the log line into a log sequence, and to perform a log sequence anomaly detection on the log sequence by using a pre-trained log sequence detection model to obtain a first anomaly score, wherein the pre-trained log sequence detection model is trained with a preset normal log sequence, and the first anomaly score represents a degree to which the log sequence deviates from the normal log sequence;
a log top field marker, configured to determine preset log top fields corresponding to the log line, to count an occurrence frequency of each preset log top field within the preset time period based on the log line to obtain log top field occurrence frequency distribution data at a current detection time, and to detect a variation degree of the log top field occurrence frequency distribution data at the current detection time relative to log top field occurrence frequency distribution data at a previous historical detection time to obtain a second anomaly score; and
a log structure marker, configured to update the log line to a log parsing tree, and to detect a variation degree of the log parsing tree at a current detection time relative to the log parsing tree at a previous historical detection time to obtain a third anomaly score.

3. The anomaly detection system according to claim 1, wherein the plurality of markers comprise:
a histogram marker, configured to extract first numerical values from the log line, to convert the extracted first numerical values into a histogram, and to detect a variation degree of the histogram at a current detection time relative to the histogram at a previous historical detection time to obtain a fourth anomaly score;
a log rate marker, configured to extract second numerical values from the log line, to fit the extracted second numerical values into a line chart, to determine an outlier determination numerical interval based on the line chart, and to obtain a fifth anomaly score based on a ratio of second numerical values outside the outlier determination numerical interval to all second numerical values;
a numeric marker, configured to extract third numerical values from the log line, to perform clustering processing on the extracted third numerical values to obtain a numerical cluster, and to calculate a deviation degree of third numerical values outside the numerical cluster relative to the numerical cluster to obtain a sixth anomaly score; and
a discrete marker, configured to extract a discrete variable from the log line, to count an occurrence frequency of each value corresponding to the discrete variable based on the extracted discrete variable to obtain discrete value occurrence frequency distribution data at a current detection time, and to detect a variation degree of the discrete value occurrence frequency distribution data at the current detection time relative to discrete value occurrence frequency distribution data at a previous historical detection time to obtain a seventh anomaly score.

4. The anomaly detection system according to claim 1, wherein each marker of the plurality of markers is further configured to:
perform normalization on the anomaly scores; and
discretize the normalized anomaly scores to obtain discrete anomaly scores.

5. The anomaly detection system according to claim 1, further comprising:
a log conversion marker, configured to convert the log line generated by the target system within the preset time period into log tokens,
wherein the model marker is further configured to combine the marker tokens and the log tokens into a token sequence.

6. The anomaly detection system according to claim 1, wherein the model marker is further configured to:
mask part of the marker tokens in the token sequence to obtain a to-be-processed token sequence comprising masked marker tokens and unmasked marker tokens;
input the to-be-processed token sequence into the pre-trained neural network model, and perform, by using the pre-trained neural network model, prediction on the masked marker tokens in the to-be-processed token sequence based on the unmasked marker tokens in the to-be-processed token sequence to obtain predicted tokens; and
calculate a loss between the predicted tokens and the masked marker tokens in the to-be-processed token sequence by using a preset loss function, and determine the loss as the overall anomaly score.

7. The anomaly detection system according to claim 6, wherein the model marker is further configured to:
obtain the baseline token sequence;
mask part of tokens in the baseline token sequence to obtain a training token sequence comprising masked tokens and unmasked tokens;
input the training token sequence into an initial neural network model, and perform, by using the initial neural network model, prediction on the masked tokens in the training token sequence based on the unmasked tokens in the training token sequence to obtain to-be-compared tokens; and
calculate a loss between the to-be-compared tokens and the masked tokens in the training token sequence by using the preset loss function, and perform parameter update on the initial neural network model based on the calculated loss to obtain the pre-trained neural network model.

8. An anomaly detection method, comprising:
performing, by a plurality of markers, anomaly detection operations on a log line generated by a target system within a preset time period to obtain anomaly scores, converting, by the plurality of markers, the anomaly scores into discrete anomaly scores, and adding, by the plurality of markers, tokens corresponding to the respective anomaly detection operations to the discrete anomaly scores to obtain marker tokens, wherein the plurality of markers are different from each other and correspond to different anomaly detection operations; and
combining, by a model marker, the marker tokens into a token sequence, and performing, by the model marker, anomaly detection on the token sequence by using a pre-trained neural network model to obtain an overall anomaly score of the target system within the preset time period, wherein whether the target system is abnormal is determined based on the overall anomaly score, wherein the pre-trained neural network model is trained with a preset baseline token sequence, and the overall anomaly score represents a degree to which the token sequence deviates from the baseline token sequence.

9. The anomaly detection method according to claim 8, wherein the performing, by a plurality of markers, anomaly detection operations on a log line generated by a target system within a preset time period comprises:
converting, by a log sequence marker, the log line into a log sequence, and performing, by the log sequence marker, a log sequence anomaly detection on the log sequence by using a pre-trained log sequence detection model to obtain a first anomaly score, wherein the pre-trained log sequence detection model is trained with a preset normal log sequence, and the first anomaly score represents a degree to which the log sequence deviates from the normal log sequence;
determining, by a log top field marker, preset log top fields corresponding to the log line, counting, by the log top field marker, an occurrence frequency of each preset log top field within the preset time period based on the log line to obtain log top field occurrence frequency distribution data at a current detection time, and detecting, by the log top field marker, a variation degree of the log top field occurrence frequency distribution data at the current detection time relative to log top field occurrence frequency distribution data at a previous historical detection time to obtain a second anomaly score; and
updating, by a log structure marker, the log line to a log parsing tree, and detecting, by the log structure marker, a variation degree of the log parsing tree at a current detection time relative to the log parsing tree at a previous historical detection time to obtain a third anomaly score.

10. The anomaly detection method according to claim 8, wherein the performing, by a plurality of markers, anomaly detection operations on a log line generated by a target system within a preset time period comprises:
extracting, by a histogram marker, first numerical values from the log line, converting, by the histogram marker, the extracted first numerical values into a histogram, and detecting, by the histogram marker, a variation degree of the histogram at a current detection time relative to the histogram at a previous historical detection time to obtain a fourth anomaly score;
extracting, by a log rate marker, second numerical values from the log line, to fit the extracted second numerical values into a line chart, determining, by the log rate marker, an outlier determination numerical interval based on the line chart, and obtaining, by the log rate marker, a fifth anomaly score based on a ratio of second numerical values outside the outlier determination numerical interval to all second numerical values;
extracting, by a numeric marker, third numerical values from the log line, performing, by the numeric marker, clustering processing on the extracted third numerical values to obtain a numerical cluster, and calculating, by the numeric marker, a deviation degree of third numerical values outside the numerical cluster relative to the numerical cluster to obtain a sixth anomaly score; and
extracting, by a discrete marker, a discrete variable from the log line, counting, by the discrete marker, an occurrence frequency of each value corresponding to the discrete variable based on the extracted discrete variable to obtain discrete value occurrence frequency distribution data at a current detection time, and detecting, by the discrete marker, a variation degree of the discrete value occurrence frequency distribution data at the current detection time relative to discrete value occurrence frequency distribution data at a previous historical detection time to obtain a seventh anomaly score.

11. The anomaly detection method according to claim 8, further comprising:
performing, by each marker of the plurality of markers, normalization on the anomaly scores; and
discretizing, by each marker of the plurality of markers, the normalized anomaly scores to obtain discrete anomaly scores.

12. The anomaly detection method according to claim 8, further comprising:
converting, by a log conversion marker, the log line generated by the target system within the preset time period into log tokens,
wherein the model marker is further configured to combine the marker tokens and the log tokens into a token sequence.

13. The anomaly detection method according to claim 8, wherein the combining, by a model marker, the marker tokens into a token sequence, and performing, by the model marker, anomaly detection on the token sequence by using a pre-trained neural network model to obtain an overall anomaly score of the target system within the preset time period comprises:
masking, by the model marker, part of the marker tokens in the token sequence to obtain a to-be-processed token sequence comprising masked marker tokens and unmasked marker tokens;
inputting, by the model marker, the to-be-processed token sequence into the pre-trained neural network model, and performing, by the model marker, prediction on the masked marker tokens in the to-be-processed token sequence by using the pre-trained neural network model based on the unmasked marker tokens in the to-be-processed token sequence to obtain predicted tokens; and
calculating, by the model marker, a loss between the predicted tokens and the masked marker tokens in the to-be-processed token sequence by using a preset loss function, and determining, by the model marker, the loss as the overall anomaly score.

14. The anomaly detection method according to claim 13, further comprising:
obtaining, by the model marker, the baseline token sequence;
masking, by the model marker, part of tokens in the baseline token sequence to obtain a training token sequence comprising masked tokens and unmasked tokens;
inputting, by the model marker, the training token sequence into an initial neural network model, and performing, by the model marker, prediction on the masked tokens in the training token sequence by using the initial neural network model based on the unmasked tokens in the training token sequence to obtain to-be-compared tokens; and
calculating, by the model marker, a loss between the to-be-compared tokens and the masked tokens in the training token sequence by using the preset loss function, and perform parameter update on the initial neural network model based on the calculated loss to obtain the pre-trained neural network model.

15. An electronic device, comprising:
a memory, configured to store a computer program; and
a processor, configured to implement the anomaly detection method according to claim 8 when executing the computer program.

16. A non-transitory computer-readable storage medium, wherein a computer-executable instruction is stored in the computer-readable storage medium, and the computer-executable instruction, when being loaded and executed by a processor, causes the processor to implement following operations:
performing, by a plurality of markers, anomaly detection operations on a log line generated by a target system within a preset time period to obtain anomaly scores, converting, by the plurality of markers, the anomaly scores into discrete anomaly scores, and adding, by the plurality of markers, tokens corresponding to the respective anomaly detection operations to the discrete anomaly scores to obtain marker tokens, wherein the plurality of markers are different from each other and correspond to different anomaly detection operations; and
combining, by a model marker, the marker tokens into a token sequence, and performing, by the model marker, anomaly detection on the token sequence by using a pre-trained neural network model to obtain an overall anomaly score of the target system within the preset time period, wherein whether the target system is abnormal is determined based on the overall anomaly score, wherein the pre-trained neural network model is trained with a preset baseline token sequence, and the overall anomaly score represents a degree to which the token sequence deviates from the baseline token sequence.
